(19) United States
(12) Patent Application Publication
(10) Pub. No.: US 2009/0220821 A1
(43) Pub. Date: Sep. 3, 2009

(54) SILICON SUBSTRATE FOR MAGNETIC RECORDING AND METHOD FOR MANUFACTURING THE SAME

(75) Inventor: Ken Ohashi, Tokyo (JP)

Correspondence Address: MYERS BIGEL SIBLEY & SAJOVEC, PO BOX 37428, RALEIGH, NC, 27627, US

(73) Assignee: Shin-Etsu Chemical Co., Ltd

(21) Appl. No.: 12/372,121

(22) Filed: Feb. 17, 2009

(30) Foreign Application Priority Data
Feb. 19, 2008 (JP) 2008-037166

(51) Int. Cl. G11B 5/00; B24B 1/00; B24B 7/24

(52) U.S. Cl. 428/826; 451/41

(57) ABSTRACT

There is provided a silicon substrate for magnetic recording that does not make the process for forming a magnetic recording layer complicated, excels in surface flatness, and has a thermal conductivity equivalent to the thermal conductivity of a single crystalline or polycrystalline bulk substrate. After forming a thin Silicon film on the surface of a polycrystalline silicon substrate subjected to rough polishing (S6), the silicon film is subjected to precision polishing (S8) such as CMP polishing to raise the flatness of the substrate. Thereby, a flat and smooth surface can be obtained without being affected by difference in the crystal orientation of polycrystalline grains and the presence of crystalline grain boundary, and a thermal conductivity equivalent to the thermal conductivity of a bulk Si substrate can be achieved.

### CROSS-RELATED APPLICATIONS

This application claims priority from Japanese Patent Application No. 2008-037166; filed Feb. 19, 2008, the disclosure of which is incorporated herein by reference in its entirety.

### BACKGROUND OF THE INVENTION

1. Field of the Invention

The present invention relates to a polycrystalline silicon substrate used for magnetic recording, and a method for manufacturing the same.

2. Description of the Related Art

In the technical field of magnetic recording, a hard disk device has been essential as a primary external recording device suitable for electronic devices such as personal computers. A hard disk is incorporated into the hard disk device as a magnetic recording medium, and conventional hard disks have adopted a system known as the “in-plane magnetic recording system (horizontal magnetic recording system)” in which magnetic information is written horizontally on the disk surface.

FIG. 3(A) is a schematic sectional view for illustrating the general layered structure in the hard disk of the horizontal magnetic recording system. On a non-magnetic substrate 101, a Cr-based foundation layer 102 formed by sputtering, a magnetic recording layer 103, and a carbon layer 104 as a protective film are sequentially deposited. On the surface of the carbon layer 104, a liquid lubricating layer 105 formed by applying a liquid lubricant (for example, refer to JP 5-143972 A). The magnetic recording layer 103 is composed of a uniaxial magnetic anisotropic Co alloy, such as CoCr, CoCrTa, and CoCrPt. The crystal grains of the Co alloy are magnetized in horizontal to the disk surface so as to record data. The arrows in the magnetic recording layer 103 in FIG. 3(A) show the directions of magnetization.

In such a horizontal magnetic recording system, however, if the size of each recording bit is reduced in order to increase the recording density, both N-poles and S-poles in adjacent recording bits repel one another so that the boundary region of the adjacent recording bits can be magnetically obscured. Therefore, in order to increase the recording density, it is necessary to reduce the thickness of the magnetic recording layer and the size of the crystal grains. It has been noted that when the crystal grains are minimized (volume reduction) and the recording bits are minimized, a “heat fluctuation” phenomenon may arise in which the magnetizing direction of the crystal grains are disturbed by thermal energy and data is erased, and it has been recognized that there is limitation in high recording density. In other words, if the KuV/k_{B}T ratio (where Ku is the crystal magnetic anisotropic energy, V is the volume of a recording bit, k_{B} is the Boltzmann constant, and T is an absolute temperature (K)) is small, the effect of heat fluctuation becomes serious.

In view of such a problem, the “vertical magnetic recording system” has been developed. In this recording system, since the magnetic recording layer is magnetized vertically to the surface of the disk, a N-pole and a S-pole are alternately bundled and bit-disposed, and the N-pole and the S-pole in a magnetic domain are adjacent one another to enhance magnetization mutually, resulting in the high stabilization of magnetized state (magnetic recording). Specifically, when the magnetizing direction is vertically recorded, the demagnetizing field of the recording bits is reduced, the thickness of the recording layer is not necessarily small compared with the thickness in the horizontal magnetic recording system. Therefore, if the recording layer is thickened in the vertical direction, the KuV/k_{B}T ratio is increased, and the effect of “heat fluctuation” can be reduced.

As described above, the vertical magnetic recording system can achieve the reduced demagnetizing field and the sufficient KuV value so as to reduce the instability of magnetization due to “heat fluctuation”, which overcomes the limit of the recording density. The vertical magnetic recording system has been practically used as a method for realizing the ultra-high density recording.

FIG. 3(B) is a schematic sectional view for illustrating a basic layered structure of a hard disk as a “vertical two-layer magnetic recording medium” having a recording layer for vertical magnetic recording on a soft magnetic lining layer. On a non-magnetic substrate 111, a soft magnetic lining layer 112, a magnetic recording layer 113, a protective layer 114, and a lubricating layer 115 are sequentially deposited. Here, the soft magnetic lining layer 112 is typically composed of permalloy, amorphous CoZrTa, or the like. As the magnetic recording layer 113, a CoCrPt-based alloy, a CoPt-based alloy, or a multilayer film formed by alternately laminating several layers of PtCo layers and ultra-thin Pd and Co films is used. The arrows in the magnetic recording layer 113 in FIG. 3(B) show the directions of magnetization.

As shown in FIG. 3(B), in the hard disk of the vertical magnetic recording system, a soft magnetic lining layer 112 is provided as the foundation layer of the magnetic recording layer 113. The magnetic characteristics thereof is “soft magnetic”, and the thickness of the layer is about 100 to 200 nm. The soft magnetic lining layer 112 is provided to obtain the effect of expanding writing magnetic field and to reduce the demagnetization field of the magnetic recording film, and functions as the path of flux from the magnetic recording layer 113 as well as the path of flux for writing from the recording head. Specifically, the soft magnetic lining layer 112 plays a roll equivalent to the iron yoke in the permanent magnet magnetic circuit. Therefore, for avoiding magnetic saturation in writing, the thickness of the soft magnetic lining layer 112 must be determined so as to be thicker than the thickness of the magnetic recording layer 113.

The horizontal magnetic recording system as shown in FIG. 3(A) is progressively replaced with the vertical magnetic recording system across a recording density of 100 Gbit to 150 Gbit per square inch as the boundary due to the recording limit caused by the heat fluctuation and the like, and the vertical magnetic recording system has been established as the mainstream system. Although the recording limit in the vertical magnetic recording system is unclear at present, it is presumed to be 500 Gbit per square inch or higher, and it is recognized that a high recording density of about 1000 Gbit per square inch will be able to be achieved. If such a high recording density is achieved, the recording capacity of 600 Gbyte to 700 Gbyte per 2.5-inch HD platter can be obtained.

Generally, for the use of the substrate for the magnetic recording medium applied to an HDD, an Al alloy substrate can be used as a substrate of a diameter of 3.5 inches, and a glass substrate is used as a substrate of a diameter of 2.5 inches. In particular, in a mobile use such as a notebook personal computer, a HDD is frequently subject to impact from the outside. It is likely that the recording medium or the substrate may be scratched or data may be destroyed due to the “hitting” of the magnetic head in a 2.5-inch HDD. Accordingly, a glass substrate having a high hardness has been used as a substrate for the magnetic recording medium.

Although the recording densities can be continuously improved by the current vertical magnetic recording using a continuous recording medium, a novel technique must be introduced on the basis of vertical magnetic recording in order to achieve a high recording density of about 1000 Gbit per square inch or higher. It is considered difficult to meet all the requirements of signal-to-noise ratio of media, thermal stability, and writability by means of vertical magnetic recording using a current continuous recording medium.

As a novel technique, a system has been considered in which, for example, a soft magnetic lining layer 122 is formed on a glass substrate 121, ribs 123 of the magnetic layer are concentrically formed thereon with different diameters, and grooves between the ribs are filled with non-magnetic material 124 by the micro-fabrication of the media (discrete track media or bit-patterned media shown in FIG. 4), as well as a heat-assisted magnetic recording system (FIG. 5(A)).

For example, in the bit-patterned media by the micro-fabrication of media, the microfabrication is required so as to have a line width finer than that of the current LSI micro-fabrication (dot processing of about 25 nm pitch and 20 nm diameter for the recording density of 1000 Gbit per square inch). Microfabrication should be carried out on the entire surface of a substrate to keep substantially all the region sound and within a certain dimensional error range and to maintain sound magnetic characteristics. Since technical difficulty is high, it is not easy to achieve a good balance between the costs and mass-production.

On the other hand, in heat-assisted magnetic recording shown in FIG. 5, a light from a laser 131 is collected (for example, 20 nm diameter or smaller), the temperature of the light focused portion of the magnetic layer 132 is elevated in a short time, and immediately, signals are written in the temperature elevating section 133 with reduced coercive force using the writing coils 134. Here, the heating spot must be decreased to the diffraction limit of the light for improving the recording density.

Therefore, it is essential that the magnetic head 139 is integrated with a near-field optical element (not shown), light is collected into the small region using near-field light while floating the bed at a low rate, and the generated heat and magnetic field are synchronized for writing. It is difficult, however, to develop a composite head of the magnetic head 139 and the near-field optical element is extremely high. In FIG. 5(A), two shields 136 are disposed adjacent to the magnetic head 139 with a certain spacing therebetween, and a GMR element 138 which is connected to a wiring 137 is disposed as a sensing element in the spacing.

While FePt or SmCo₅ having high crystalline magnetic anisotropy is considered as one of candidate materials for the magnetic recording layer, FePt and SmCo require high temperature in the film-forming process due to the significantly different film-forming condition from a conventional CoCrPt-based material.

Even if the limit of magnetic recording density can be overcome by any method, there is an extremely large barrier between technical difficulty and mass production.

Although FePt and the like are studied as a next-generation material for recording layers in heat-assisted magnetic recording, heat treatment at a high temperature, such as about 600° C. is required for elevating coercive force. Therefore, the lowering of the temperature for heat treatment is studied; however, heat treatment at 400° C. or higher is required. These temperatures are higher than temperatures endurable by the use of presently used amorphous glass substrates, and the substrates are softened. An Al substrate having amorphous NiP film formed by plating also cannot resist the treatment at such a high temperature. NiP is crystallized at such a high temperature, and once flattened surface characteristics are significantly lowered. Therefore, a substrate suitable for a heat-assisted magnetic recording film is required.

While a sapphire-glass substrate, a SiC substrate, a carbon substrate, and the like can replace the glass substrates and Al substrates, none of these are satisfactory at present in terms of strength, workability, costs, surface flatness, and film formability.

### SUMMARY OF THE INVENTION

Taking these situations into account, the present inventors have already proposed the use of a single crystalline silicon (Si) substrate as a substrate for an HDD recording film (for example, refer to JP 2005-108407 A).

The single crystalline Si substrate has been widely used as a substrate for manufacturing an LSI. Since the single crystalline Si substrate excels in surface flatness, environmental stability, and reliability, as well as high rigidity compared with the rigidity of glass, the single crystalline Si substrate is suitable for an HDD substrate. In addition, the single crystalline Si substrate shows semiconductive behavior unlike an insulating glass substrate, often contains p-type or n-type dopant, and has conductivity to a certain degree. Therefore, “charge-up” is relatively reduced in the sputtering process, enabling the direct sputtering or the bias sputtering of a metal film. Furthermore, since the single crystalline Si substrate has favorable heat conductivity and high heat resistance, the substrate can easily be heated to a high temperature, and good compatibility with the sputtering film forming is extremely high. Moreover, since the crystal purity of the Si substrate is extremely high, there are advantages that the surface of the substrate after processing is stable, and the temporal change can be ignored.

However, the only weak point is the high costs of the 48 mm-diameter or larger single crystalline Si wafer.

The present inventors have also proposed the use of a polycrystalline silicon (Si) substrate as a substrate of a HDD recording film. Polycrystalline Si has various selections of material in terms of purity, and excels in the cost performance of the substrate.

The use of a polycrystalline substrate as it is, and the use of a polycrystalline substrate after forming an oxide film on the surface and planarizing and flattening the film have been developed. Although the former has a simple configuration wherein the single crystalline Si is simply replaced by the polycrystalline Si, the polycrystalline Si substrate is relatively inferior to the single crystalline Si substrate in the strength of the substrate and the defect of polished surface. The strength of the latter is higher than the strength of the single crystalline Si substrate, and since the oxide film is amorphous, excellent surface characteristics can be obtained after polishing. However, since the oxide film is present on the surface, the heat conductivity from the surface of the substrate in the vertical direction is affected. Particularly in the heat-assisted magnetic recording, the heat dissipation design for heat applied in writing may be affected.

To solve such problems, an object of the present invention is to provide a polycrystalline silicon substrate for a magnetic recording medium and a recording medium that do not impair the heat conducting characteristics of the polycrystalline silicon substrate in the magnetic recording substrate having a diameter of 48 mm or larger in particular, excel in surface flatness and smoothness, and have high cost performance.

To solve the above-described problems, the silicon substrate for magnetic recording according to the present invention includes a silicon film on the major surface of a polycrystalline silicon underlying substrate of a purity of no less than 99.99%, and the surface of the silicon film may be smoothed. Preferably, the surface of the surface-coated silicon substrate for magnetic recording of the present invention may be smoothed so as to have the root mean square value of 0.5 nm or smaller.

As the polycrystalline silicon substrate used as the silicon substrate for magnetic recording of the present invention, the substrate having a diameter of 48 mm or larger can be preferably adopted. The thickness of the silicon film may be 50 nm to 5 μm. If the thickness is less than 50 nm, there is possibility that the surface of the underlying substrate is exposed due to the insufficient in-plane distribution of the silicon film thickness. If the thickness exceeds 5 μm, the time of forming the film tends to be long, and surface roughness becomes significant by the effect of residual stress. The silicon film is amorphous or micro-crystalline. The term “micro-crystalline” means a crystal normally having a grain diameter of 5 nm to 50 nm. Since the mean grain size of the polycrystalline grains in the polycrystalline silicon underlying substrate is preferably 1 mm to 15 mm as described later, the layer of the polycrystalline silicon underlying substrate and the layer of the silicon film can be apparently distinguished by the observation of the crystal structure. The mean thickness of the silicon film in the silicon substrate for magnetic recording can be measured by the SEM observation of the cross-section of the substrate.

Either the Si amorphous film or the micro-crystalline film can be used, and although the former can be easily formed, since crystallization begins from the amorphous state at 300° C. or higher, they can be selected depending on the film forming temperature for the recording media.

The method for manufacturing a silicon substrate for magnetic recording according to the present invention may comprise the steps of: subjecting a major surface of a polycrystalline silicon substrate having a purity of no less than 99.99% to precision grinding or rough polishing; forming an amorphous silicon film or a micro-crystalline silicon film on the silicon substrate surface; and polishing the silicon film so as to have a smooth surface.

Since the heat conductivity of the polycrystalline silicon substrate of the present invention may be substantially the same level as that of the upper silicon film, by providing a magnetic recording layer or the like on the silicon substrate, the magnetic recording medium according to the present invention suited for heat-assisted recording can be obtained.

The method for manufacturing a silicon substrate for magnetic recording of the present invention may comprise the steps of subjecting a major surface of a polycrystalline silicon substrate having a purity of no less than 99.99% (S6) to rough polishing or precision grinding; forming a silicon film on the major surface of the silicon substrate (S7); and final polishing the silicon film (S8) so as to have a smooth surface. The silicon film forming process (S7) may be implemented by forming a silicon film on the major surface of the polycrystalline silicon substrate by CVD or PVD. The silicon film polishing process (S8) may be implemented by performing CMP treating to make the square mean value of the roughness of the substrate be 0.5 nm or less.

By properly forming a recording film on the polished substrate, a magnetic recording medium is formed.

By forming and polishing the silicon film thereon, the silicon substrate for magnetic recording or a magnetic recording medium may achieve surface flatness and smoothness, the improved strength of the thin plate due to the coverage of grain boundaries causing the brittleness of the substrate and a high cost performance without detracting the favorable heat conducting characteristics of the polycrystalline silicon substrate.

### BRIEF DESCRIPTION OF THE DRAWINGS

FIG. 1 is a flow chart showing the process of the present invention;

FIGS. 2(A) and (B) show the results of the third embodiment of the present invention: (A) showing a SEM photograph of the cross-section of a substrate wherein an amorphous silicon film is formed on an Si substrate having an SiO film of a thickness of 300 nm under the same conditions as in the third embodiment; and (B) showing the result of evaluating roughness of the third embodiment after final polishing;

FIG. 3(A) is a sectional view for illustrating an ordinary layered structure of a hard disk using a horizontal magnetic recording system; FIG. 3(B) is a sectional view for illustrating a basic layered structure of a hard disk wherein a recording layer for vertical magnetic recording on a soft magnetic lining layer as a “vertical bilayer magnetic recording medium”;

FIG. 4 is a schematic diagram showing an embodiment of a discrete track recording medium of a next-generation recording system, which is an object of the present invention; and

FIG. 5(A) is a schematic diagram showing a device configuration of a heat-assisted magnetic recording system, and FIG. 5(B) is a graph showing change in coercivity in heating and heat dissipating processes.

### DETAILED DESCRIPTION OF THE PREFERRED EMBODIMENTS

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs.

Hereinafter, preferred embodiments of the present invention will be described. However, it is to be understood that the present invention is not limited thereto.

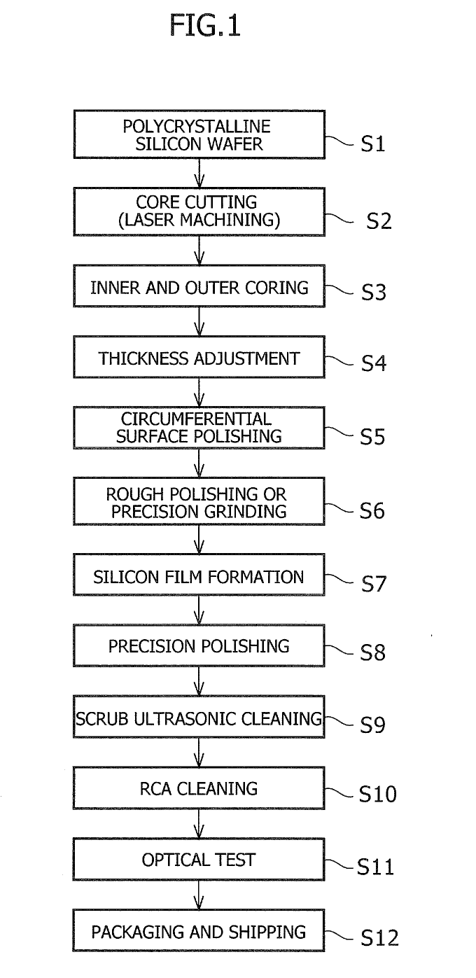

FIG. 1 is a flow chart for illustrating an example of the process for manufacturing a Si substrate for a magnetic recording medium according to the present invention. First, a polycrystalline Si wafer is prepared so as to obtain the Si substrate for HD by core-cutting (S1). Although it is more preferable that the purity of the polycrystalline Si wafer is higher, the purity of so-called “semiconductor grade” (generally “eleven-nines” (99.999999999%) or higher) is not required, but the purity of the “solar cell grade” is sufficient. The purity of the polycrystalline Si wafer of the solar cell grade is generally about “eight-nines” (99.999999%). In the present invention, however, not lower than “four-nines” (99.99%) can be permitted. In the uses of the substrate for magnetic recording according to the present invention, since polycrystalline Si is basically used as the structural material, the control of the quantity of dopants, such as boron (B) and phosphorus (P) is not required unlike application to solar cells. Although it is preferable that the quantity of insoluble impurities (SiNₓ, SiC, etc.) contained in a material polycrystalline Si wafer is small, since the upper portion is coated with a silicon film, they do not cause problems practically.

The shape of the polycrystalline Si wafer can be rectangular or disk. Rectangular is more preferable in terms of material yield. Since the shape of polycrystalline Si wafers used for solar cells is generally a rectangle of about 150 mm square, the example using the polycrystalline Si wafer of this shape is shown in the process of the examples. The average grain size of the polycrystalline grains is preferably 1 mm to 15 mm in terms of the mechanical strength and impact resistance of the polycrystalline Si wafer itself, smaller grains having a diameter of no less than 10 um can be mixed in the present invention because the upper portion of the wafer is coated with a silicon film to improve mechanical strength.

Although various methods, such as cup cutting using diamond grinding stone, ultrasonic cutting, blast processing, and water-jet treatment, are available for core-cutting (S2), laser core-cutting by means of a solid-state laser is preferable in terms of the processing speed, the reduction of margin necessary for cutting, the ease of aperture switching, and the ease of jig fabrication and post processing. Solid laser has a high power density, can concentrate beams, and has advantages of little meltdown residues (dross) and relatively clean processed surface. The examples of laser-beam sources for this case, include Nd-YAG laser and Yb-YAG laser.

After performing coring and inner and outer circumferential surface coring (S3) and polishing or lapping for thickness adjustment (S4) on the Si substrate obtained by core-cutting, circumferential surface polishing is performed so as not to cause chipping or the like in subsequent polishing (S5).

On the Si substrate thus obtained, rough polishing or precision grinding (S6) is performed as described above in order to substantially flatten the surface. In the present invention, the rough polishing for surface flattening is performed by CMP processing using neutral or alkaline slurry. Alternatively, the precision grinding is performed using fine grain diamond fixed grinding grain (e.g., #4000 or finer) on the ductile region. The reason why polishing is performed on the ductile region is to reduce the layer deteriorated by processing.

Since the Si substrate, which is used in the present invention, is polycrystalline, respective crystal grains have different crystal orientations. If “rough polishing” is performed using ordinary CMP, steps are formed for respective crystal grains due to different polishing speeds in respective crystal grains, and favorable surface flatness cannot be achieved. Therefore, CMP having higher ratio of mechanical polishing is performed to suppress formation of inter-grain steps as much as possible using slurry of a neutral to alkaline range (pH 7 to 10). If the pH of the slurry exceeds 10, the ratio of chemical polishing increases, and the inter-grain steps having different crystal orientations become excessively large. If the pH is at 7 or lower, mechanical polishing becomes the main part of polishing, and polishing speed becomes excessively low. In the rough polishing slurry, for example, ceria or colloidal silica can be used, and the average particle diameter may be 30 nm to 100 nm. Since the polishing speed is important in the rough polishing, the polishing pressure can be set to 5 to 50 kg/cm², which is a little higher than the polishing pressure in the following final polishing process (S8), and the polishing time can be set to 5 to 60 minutes. Since the rough polishing is a process for substantially removing the thickness irregularity and surface steps of the polycrystalline silicon substrate, the flatness of the surface of the Si substrate may be 1 nm or smaller and fine scratches may be present. Precision grinding may also be performed. Although a flat surface cannot be obtained by precision grinding as by polishing, the grinding speed is further high since fixed grind grains are used, and flatness and waviness are favorable, if the height of ground groove can be about 20 nm to 30 nm, the flatness can be achieved by subsequent final polishing (S8).

Next, a silicon film (amorphous or micro-crystalline) is formed on the surface of the Si substrate after rough polishing (S7). When the silicon film is provided on the surface of the substrate, a grain boundary, which is a cause of substrate brittleness, can be coated, and the mechanical strength of the thin plate may increase. Since the film is polycrystalline or amorphous, and has no cleavage to a specific direction, the strength and impact resistance of the substrate can be improved. Furthermore, since the silicon film is amorphous or micro-crystalline, the silicon film is unrelated to the inter-grain crystal orientation of the original polycrystalline substrate, and the assurance of surface flatness becomes easy.

In the present invention, the formation of the silicon film (S7) may be carried out using CVD or PVD. CVD includes thermal CVD, plasma CVD, and the like. In the present invention, after the formation of the film using CVD, the film is flattened by polishing the surface. Therefore, a certain film thickness is required, and for example, the film thickness of 500 nm or more when the film is formed is preferable. The thicker silicon film is preferable because the processing margin can be obtained in polishing. However, since excessive time and costs are required in film formation, the thickness of the film when formed is preferably 5 μm or thinner. As described above, a certain film thickness is required, plasma CVD, by which the film forming speed is higher than thermal CVD, is more suitable.

Although PVD methods include the sputtering method, the ion plating method, and vapor deposition method (including laser deposition method), the magnetron sputtering method and the ion plating method are suitable due to relatively high film forming speed.

Since the film is formed on the surface of polycrystalline Si that has been subjected to rough polishing (S6), the surface characteristics of the formed film are relatively favorable. Although the quality of silicon films are different depending on film forming methods, theoretically dense films can be formed when the temperature of plasma and flying particles is high at the film forming. For this reason, the methods wherein the effective temperature of flying particles is high, such as plasma CVD and magnetron sputtering, are preferable.

The formed thin Si film can be either amorphous or micro-crystalline. However, when a magnetic recording layer is formed on the substrate, the amorphous silicon film is preferable when the substrate temperature is 300° C. or lower, and the micro-crystalline film is preferable when the substrate temperature is higher than 300° C. When the amorphous silicon film is compared with the micro-crystalline silicon film, the film forming speed of the former is generally higher, and the film forming speed of the latter is relatively lower. However, even in the micro-crystalline silicon film, high-speed film formation is feasible (1 nm/sec or more) by the atmospheric pressure plasma CVD or high-frequency plasma CVD.

After forming the amorphous silicon film or the micro-crystalline silicon film, final CMP polishing is performed to the polycrystalline silicon substrate with the thin film (S8). In the present invention, by forming the thin Si film (amorphous or micro-crystalline) (S7), fine scratches and steps on the roughly polished surface are slightly remedied and improved. By final CMP polishing of the thin film surface, a favorable flat surface having a final Ra of 0.5 nm or less can be obtained in a relatively short time.

The thickness of the silicon film after polishing can be 50 nm or more and 5 μm or less. If the thickness is less than 50 nm, there is possibility that the underlying substrate is exposed due to the insufficient in-plane distribution of the silicon film thickness. If the thickness exceeds 5 μm, since the time of forming the film tends to be long, and surface roughness becomes significant due to the residual stress, the silicon film thicker than 5 μm is not preferable.

The slurry for CMP polishing used in final polishing process after forming the thin Si film (S8) can be ordinary one. For example, the slurry of colloidal silica having an average particle diameter of 20 to 80 nm is used in an alkaline range of pH 7 to 10. The pH is adjusted by adding hydrochloric acid, sulfuric acid, hydrofluoric acid, or the like. The concentration of colloidal silica is about 5 to 30%. CMP is performed for about 5 to 60 minutes using slurry wherein colloidal silica is dispersed to obtain a desired surface flatness. Since a favorable surface having no scratches must be obtained, final polishing (S8) is preferably performed under a polishing pressure of 1 to 10 kg/cm², which is lower than the pressure for rough polishing.

Of course, final polishing of two or more steps can be performed for obtaining a more favorable surface by the final polishing process (S8).

After the polishing process (S 8), scrub cleaning (S9) and RCA cleaning (S10) are performed to clean the surface of the substrate. Thereafter, the surface of the substrate is subjected to an optical test (S11), and the substrate is packaged and shipped (S12).

The polycrystalline silicon substrate thus obtained has the root mean square values of 0.3 nm or less for both waviness and micro-waviness, and can obtain the surface characteristics sufficient to the substrate for a hard disk.

By forming the layers including a magnetic recording layer on the above-described polycrystalline silicon substrate with the silicon film, a magnetic recording medium can be obtained.

The present invention will be more specifically described below referring to examples. However, the present invention is not limited to these examples.

### Examples 1 to 7

Wafer of polycrystalline Si each having a “five-nines” purity (156 mm square, 0.6 mm thickness) was prepared (S1). From the polycrystalline Si wafers, Si substrates each having an outside diameter of 65 mm and an inside diameter of 20 mm were core-cutted using a laser processing machine (YAG laser, 1064 nm wavelength) to obtain four substrates per wafer (S2). These substrates were subjected to inside/outside coring (S3), thickness adjustment (S4), and end surface polishing (S5).

Next, rough polishing was performed on the major surfaces of the polycrystalline silicon substrate (S6). The rough polishing was performed by a double-sided polisher using a slurry of colloidal silica having a pH of 8.5 (an average particle diameter of 40 nm) under a polishing pressure of 10 kg/cm² for 10 to 30 minutes by a maximum of 1500 nm. The inter-grain step in the major surface of the Si substrate after rough polishing, measured by an optical tester (Zygo) was about 5 nm.

An amorphous silicon film or a micro-crystalline silicon film of a thickness of 1000 nm to 6000 nm was formed on the rough-polished substrate using a CVD apparatus or a PVD apparatus (S7). Here, a high-frequency plasma CVD was used for the CVD film forming, and a magnetron sputter was used for forming the PVD film.

In the high-frequency plasma CVD film forming, an amorphous silicon film having a thickness of 1000 nm to 5000 nm was formed on the unheated polycrystalline Si substrate by applying high frequency of 13.56 MHz so that the back pressure became 1 to 3 Torr while supplying silane gas. Under the same conditions, a micro-crystalline silicon film having a thickness of 2000 nm to 5000 nm was formed on the Si substrate whose temperature had been elevated to 400° C.

In the magnetron sputtering film forming, an Si target was used in DC sputtering, Ar gas was supplied, and sputtering was performed under a back pressure of 5×10⁻³ Torr to make the film have a thickness of about 1500 nm on the polycrystalline silicon substrate. At this time, the target was not specially heated. The formed silicon film was of a micro-crystal type.

The thickness of the silicon film and the presence of crystallization were measured using fluorescent X-ray and X-ray diffraction. By either measurement, the film thickness distribution in the surface was as small as 2% or less, exhibiting favorable film thickness uniformity. Since steps caused by performing rough polishing (inter-grain step and step caused by grain boundaries) were coated with the silicon film, the steps were more or less reduced to about 3 nm. When no specified reflection peak was observed in the diffraction diagram of the X-ray diffraction, the silicon was judged as amorphous.

Next, CMP polishing was performed using fine colloidal silica particle for polishing (pH: 10, particle diameter: 30 nm) under a polishing pressure of 5 kg/cm² to grind the silicon film by 200 nm to 2000 nm from the surface (S8), and a flat polished surface that has little minute defect was obtained.

After removing residual colloidal silica from the polycrystalline silicon substrate with these silicon films by scrub cleaning (S9), precision cleaning (RCA cleaning: S10) was performed, and the surface characteristics of the polycrystalline silicon substrate were evaluated by the optical test (C11). Specifically, the curvature (waviness measured by an Opti-Flat manufactured by Shifter Corporation; micro-waviness measured by an optical measuring apparatus manufactured by Zygo Corporation) and the flatness (roughness measured by an AFM apparatus manufactured by Digital Instrument Corporation) of the polished surface were evaluated. In the roughness, waviness, and micro-waviness, mean square values were adopted.

In Table 1, the results of sample evaluation of Samples 1 to 7 obtained as described above (Ra: roughness, Wa: waviness, and μ-Wa: micro-waviness) are summarized. As Comparative Example 1, the evaluation result of the sample prepared in the same manner as other samples but without coated by the silicon film (non-coating) is shown for comparison.

TABLE 1

| | Si film and process condition | | | | | | |
|---|---|---|---|---|---|---|---|
| | | | | Precision | | | |
| | | Film | Coating | polishing | | | |
| | | forming | thickness | thickness | Ra | Wa | μ- |
| | Si film | method | (nm) | (nm) | (nm) | (nm) | Wa(nm) |
| Example 1 | Amorphous | Plasma | 1080 | 700 | 0.22 | 0.23 | 0.21 |
| | | CVD | | | | | |
| Example 2 | Amorphous | Plasma | 2570 | 1500 | 0.15 | 0.2 | 0.18 |
| | | CVD | | | | | |
| Example 3 | Amorphous | Plasma | 4240 | 2000 | 0.27 | 0.27 | 0.29 |
| | | CVD | | | | | |
| Example 4 | Micro- | Plasma | 2220 | 1500 | 0.17 | 0.21 | 0.22 |
| | crystalline | CVD | | | | | |
| Example 5 | Micro- | Plasma | 5100 | 1500 | 0.26 | 0.29 | 0.32 |
| | crystalline | CVD | | | | | |
| Example 6 | Micro- | Magnetron | 1530 | 1000 | 0.2 | 0.22 | 0.22 |
| | crystalline | sputtering | | | | | |
| Example 7 | Micro- | Magnetron | 1250 | 600 | 0.25 | 0.27 | 0.3 |
| | crystalline | sputtering | | | | | |
| Comparative | Non coating | — | 0 | — | 0.21 | 4.5 | 2.7 |
| example 1 | | | | | | | |

As seen from Table 1, the surface of the polycrystalline silicon substrate with the silicon film obtained by the method according to the present invention was flat, smooth, and favorable. No steps reflecting crystal grain distribution as observed on the polycrystalline Si surface according to the Comparative Example were observed.

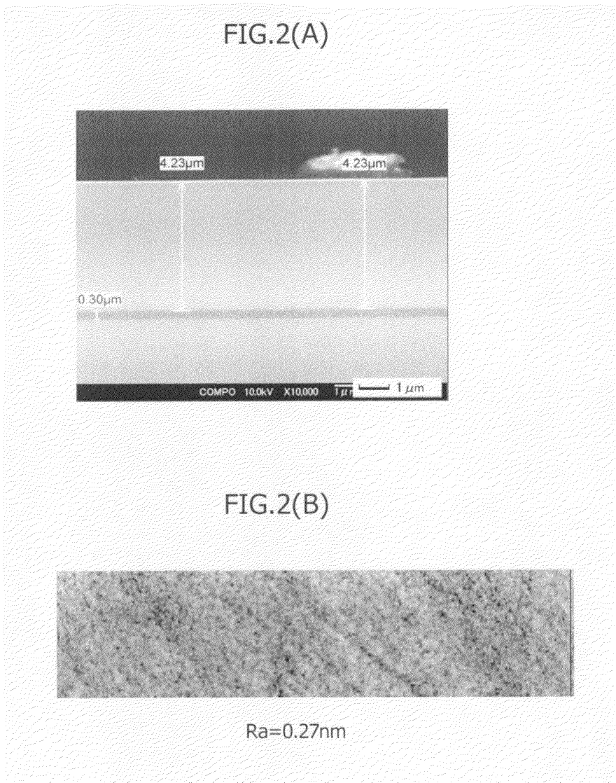

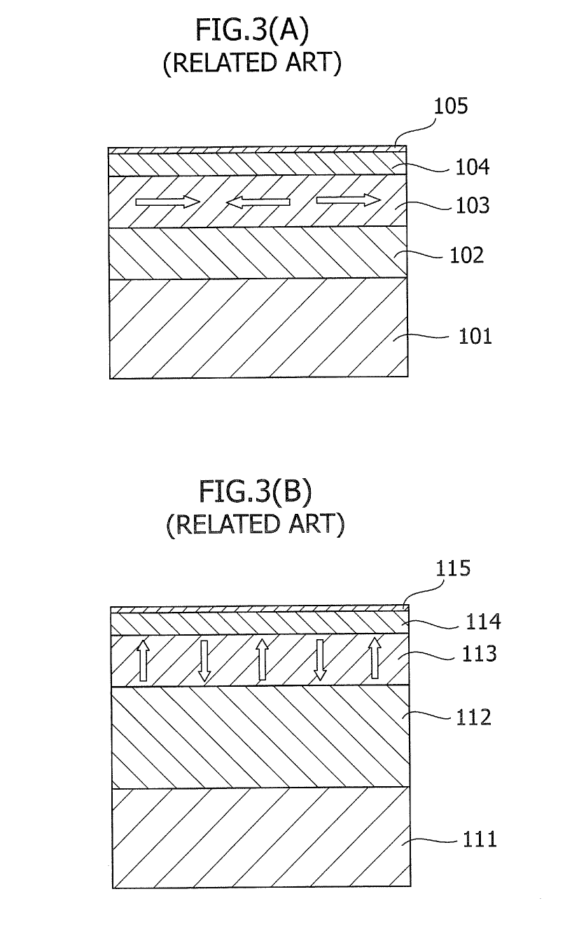

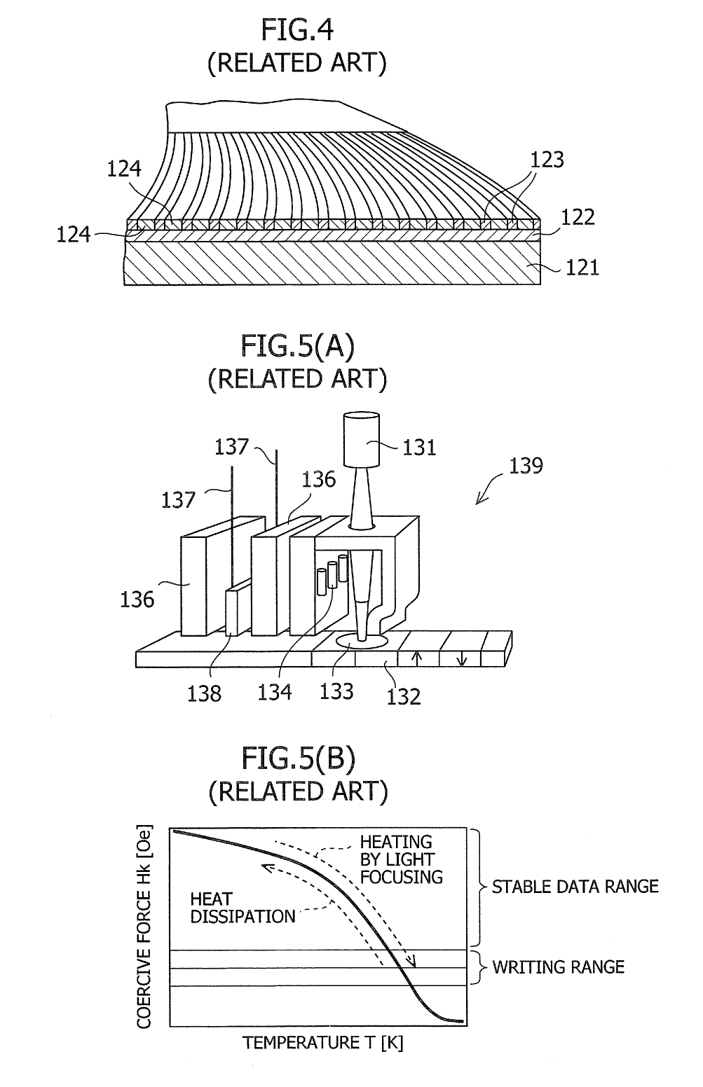

FIG. 2(A) shows a cross-sectional photo when an amorphous film is formed on the SiO₂ film/Si substrate under the same film forming conditions as in Example 3. The reason why the photo on the SiO₂ film is that film formation on the Si substrate cannot distinguish between the substrate and the film. Since the film thicknesses are substantially the same, it is considered that the film is substantially the same as the film in Example 3. The result of roughness of the surface measured by AFM after the amorphous silicon film in Example 3 is polished under the conditions described above (polishing pressure: 5 kg/cm²) (after S8) is shown in FIG. 2(B).

The thermal conductivities of samples according to Example 3, Example 4 and Example 6 after polishing were measured. The result was substantially the same as the result of Comparative Example 1, which was composed of a polycrystalline silicon substrate alone, and was 1.38 W/m-K. Little effect of forming a silicon film on the surface could be found.

The present invention enables to provide an Si substrate for magnetic recording medium that does not make the process for treatment and the process for forming the magnetic recording layer be complicated, excels in surface flatness, and has thermal conductivity same as the thermal conductivity of single-crystalline and polycrystalline bulk substrate.

1. A surface-coated silicon substrate for magnetic recording, comprising a polycrystalline silicon substrate and an amorphous or micro-crystalline silicon film having an average thickness of not less than 50 nm and not more than 5 μm on the polycrystalline silicon substrate,
wherein a surface of the amorphous or micro-crystalline silicon film is smoothed.

2. The surface-coated silicon substrate for magnetic recording according to claim 1, wherein the surface of the amorphous silicon film or micro-crystalline silicon film has an average roughness Ra of not more than 0.5 nm.

3. A method for manufacturing a surface-coated silicon substrate for magnetic recording comprising the steps of:
subjecting a major surface of a polycrystalline silicon substrate to precision grinding or rough polishing;
forming an amorphous silicon film or a micro-crystalline silicon film on the silicon substrate; and
polishing the silicon film so as to have a smooth surface.
